(19) United States
(12) Patent Application Publication
(10) Pub. No.: US 2024/0151867 A1
(43) Pub. Date: May 9, 2024

(54) PROBABILISTIC CLASSIFICATION OF ROCK TYPES USING MULTIVARIATE PROBABILITY DISTRIBUTIONS OF SUBSURFACE PROPERTIES AND SPATIAL CONTINUITY

(71) Applicant: Chevron U.S.A. Inc., San Ramon, CA (US)

(72) Inventors: Lewis Li, Houston, TX (US); Tao Sun, Missouri City, TX (US)

(21) Appl. No.: 17/982,089

(22) Filed: Nov. 7, 2022

(51) Int. Cl. G01V 1/30

(52) U.S. Cl. CPC G01V 1/306; G01V 1/308

(57) ABSTRACT

A subsurface representation of a subsurface region includes cells that define subsurface propert(ies) at different locations within the subsurface region. Initial classification of rock types within portions of the subsurface representation is obtained and used to determine probability distributions of the subsurface propert(ies) for the rock types. The probability distributions of the subsurface propert(ies) for the rock types and a spatial distribution of rock types within the subsurface representation are used in an iterative process to determine classification of rock types within the subsurface representation.

### FIELD

The present disclosure relates generally to the field of classifying rock types using multivariate probability distributions of subsurface properties and spatial continuity.

### BACKGROUND

Digital representations of subsurface regions may be generated with various subsurface properties. Classification of rock types within the digital representations using deterministic thresholding/clustering of subsurface properties may result in inaccurate (e.g., non-geological, inconsistent) classification of rock types and noisy results. Machine-learning approaches to classify rock types may require large volumes of manually labeled data.

### SUMMARY

This disclosure relates to classifying rock types. Subsurface representation information and/or other information may be obtained. The subsurface representation information may define a subsurface representation. The subsurface representation may characterize subsurface configuration of a region using values of one or more subsurface properties. Initial classification of rock types within portions of the subsurface representation may be obtained. A first portion of the subsurface representation may be initially classified as a first rock type, a second portion of the subsurface representation may be initially classified as a second rock type, and/or other portion(s) of the subsurface representation may be initially classified as other rock type(s).

Probability distributions for the rock types may be determined based on the values of the subsurface propert(ies) within the portions of the subsurface representation and/or other information. One or more probability distributions for the first rock type may be determined based on the values of the subsurface propert(ies) within the first portion of the subsurface representation and/or other information. One or more probability distributions for the second rock type may be determined based on the values of the subsurface propert(ies) within the second portion of the subsurface representation and/or other information. An individual probability distribution may define likelihood of a given rock type as a function of values of a given subsurface property. Classification of the rock types within the subsurface representation may be determined based on the probability distributions for the rock types, a spatial distribution of the classification of the rock types within the subsurface representation, and/or other information.

A system for classifying rock types may include one or more electronic storage, one or more processors and/or other components. The electronic storage may store subsurface representation information, information relating to subsurface representations, information relating to a region, information relating to subsurface configuration, information relating to subsurface properties, information relating to initial classification of rock types, information relating to probability distributions for rock types, information relating to classification of rock types, information relating to spatial distribution of the classification of rock types, and/or other information.

The processor(s) may be configured by machine-readable instructions. Executing the machine-readable instructions may cause the processor(s) to facilitate classifying rock types. The machine-readable instructions may include one or more computer program components. The computer program components may include one or more of a subsurface representation component, an initial classification component, a probability distribution component, a classification component, and/or other computer program components.

The subsurface representation component may be configured to obtain subsurface representation information and/or other information. The subsurface representation information may define a subsurface representation. A subsurface representation may characterize subsurface configuration of a region using values of one or more subsurface properties.

In some implementations, the subsurface representation may characterize simulated subsurface configuration of a simulated region.

In some implementations, the subsurface representation may include a two-dimensional subsurface representation. The two-dimensional subsurface representation may represent a slice of a subsurface region.

In some implementations, the subsurface representation may include a three-dimensional subsurface representation. The three-dimensional subsurface representation may represent a subsurface region.

The initial classification component may be configured to obtain initial classification of rock types within portions of the subsurface representation. A first portion of a subsurface representation may be initially classified as a first rock type, a second portion of the subsurface representation may be initially classified as a second rock type, and/or other portion(s) of the subsurface representation may be initially classified as other rock type(s).

In some implementations, the initial classification of rock types within the portions of the subsurface representation may be obtained from one or more slices of the three-dimensional subsurface representation representing one or more slices of the subsurface region. In some implementations, the initial classification of rock types within the portions of the subsurface representation may be obtained from one or more three-dimensional parts of the three-dimensional subsurface representation representing one or more three-dimensional parts of the subsurface region:

The probability distribution component may be configured to determine probability distributions for the rock types based on the values of the subsurface propert(ies) within the portions of the subsurface representation and/or other information. An individual probability distribution may define likelihood of a given rock type as a function of values of a given subsurface property. One or more probability distributions for the first rock type may be determined based on the values of the subsurface propert(ies) within the first portion of the subsurface representation and/or other information. One or more probability distributions for the second rock type may be determined based on the values of the subsurface propert(ies) within the second portion of the subsurface representation and/or other information.

The classification component may be configured to determine classification of the rock types within the subsurface representation. The classification of the rock types within the subsurface representation may be determined based on the probability distributions for the rock types, a spatial distribution of the classification of the rock types within the subsurface representation, and/or other information.

In some implementations, the classification of the rock types within the subsurface representation may be determined using an iterative approach in which a global energy function is reduced. The iterative approach may include updating of the probability distributions for the rock types based on changes in the classification of the rock types.

The global energy function may include a misfit classification value, a smoothness penalty value, and/or other values. The misfit classification value may be determined based on difference between a current classification of a given cell within the subsurface representation and a probabilistic classification of the given cell, and/or other information. The smoothness penalty value may be determined based on difference in classification between neighboring cells of the subsurface representation, and/or other information.

In some implementations, the probabilistic classification of a particular cell of the subsurface representation may be determined by selecting a particular rock type with the highest likelihood for value(s) of the subsurface propert(ies) associated with the particular cell.

In some implementations, the subsurface representation may characterize the subsurface configuration of the region using values of multiple subsurface properties, and the multiple subsurface properties may be weighted for determination of the misfit classification value.

In some implementations, the classification of the rock types within a two-dimensional subsurface representation (representing a slice of a subsurface region) may be used as the initial classification of the rock types within one or more adjacent two-dimensional subsurface representations. The adjacent two-dimensional subsurface representation(s) may represent one or more adjacent slices of the subsurface region. Multiple two-dimensional subsurface representations, in which the classification of the rock types have been determined, may be combined to generate a three-dimensional subsurface representation for the subsurface region with the classification of the rock types.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for classifying rock types.

FIG. 2 illustrates an example method for classifying rock types.

FIG. 3A illustrates example grain size distribution histogram for rock types.

FIG. 3B illustrates example classification of rock types.

FIG. 4 illustrates an example initial classification of rock types.

FIG. 5 illustrates example probability distributions for rock types.

FIG. 6 illustrates example likelihoods for different rock types.

FIG. 7 illustrates an example classification of rock type using highest likelihoods for rock types.

FIG. 8 illustrates example results of iteratively classifying rock types.

FIG. 9 illustrates example results of iteratively classifying rock types.

### DETAILED DESCRIPTION

The present disclosure relates to classifying rock types. A subsurface representation of a subsurface region includes cells that define subsurface propert(ies) at different locations within the subsurface region. Initial classification of rock types within portions of the subsurface representation is obtained and used to determine probability distributions of the subsurface propert(ies) for the rock types. The probability distributions of the subsurface propert(ies) for the rock types and a spatial distribution of rock types within the subsurface representation are used in an iterative process to determine classification of rock types within the subsurface representation.

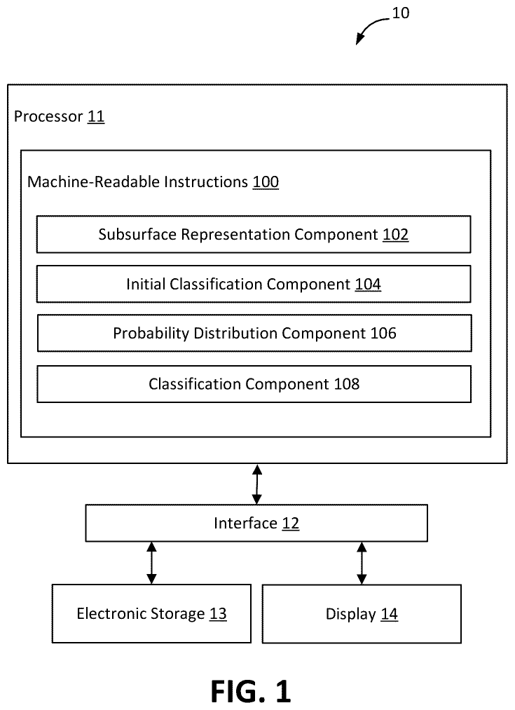

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Subsurface representation information and/or other information may be obtained by the processor 11. The subsurface representation information may define a subsurface representation. The subsurface representation may characterize subsurface configuration of a region using values of one or more subsurface properties. Initial classification of rock types within portions of the subsurface representation may be obtained by the processor 11. A first portion of the subsurface representation may be initially classified as a first rock type, a second portion of the subsurface representation may be initially classified as a second rock type, and/or other portion(s) of the subsurface representation may be initially classified as other rock type(s).

Probability distributions for the rock types may be determined by the processor 11 based on the values of the subsurface propert(ies) within the portions of the subsurface representation that are initially classified and/or other information. One or more probability distributions for the first rock type may be determined based on the values of the subsurface propert(ies) within the first portion of the subsurface representation that have been initially classified as the first rock type and/or other information. One or more probability distributions for the second rock type may be determined based on the values of the subsurface propert(ies) within the second portion of the subsurface representation that have been initially classified as the second rock type and/or other information. An individual probability distribution may define likelihood of a given rock type as a function of values of a given subsurface property. Classification of the rock types within the subsurface representation may be determined by the processor 11 based on the probability distributions for the rock types, a spatial distribution of the classification of the rock types within the subsurface representation, and/or other information.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store subsurface representation information, information relating to subsurface representations, information relating to a region, information relating to subsurface configuration, information relating to subsurface properties, information relating to initial classification of rock types, information relating to probability distributions for rock types, information relating to classification of rock types, information relating to spatial distribution of the classification of rock types, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present subsurface representation information, information relating to subsurface representations, information relating to a region, information relating to subsurface configuration, information relating to subsurface properties, information relating to initial classification of rock types, information relating to probability distributions for rock types, information relating to classification of rock types, information relating to spatial distribution of the classification of rock types, and/or other information.

Subsurface representations of subsurface regions (e.g., three-dimensional high resolution models of stratigraphy) may be generated to serve as digital analogs for subsurface modeling and characterization. For example, subsurface representations of a reservoir may be generated for use in reservoir modeling and characterization. Subsurface representations may be generated using a forward simulation of sediment transport, which provides a series of attributes (subsurface properties) pertaining to the simulation, such as grain size of the deposition at a given spatial-temporal location.

A rock type may refer to grouping and/or categorization of rocks based on their lithological similarity. A rock type may refer to a body of rock with particular subsurface properties. A rock type may include rocks with same/similar subsurface properties. A rock type may refer to a particular kind of rock. Accurate and precise identification of lithological rock types is vital to subsurface modeling. For example, direct application with Multi-Point Statistics (MPS) requires a training image of rock types (facies), and soft constraints within Learned Stratigraphic Simulation (LSS) could benefit greatly from a subsurface representation with accurate rock type classification. Thus, it is desirable to accurately classify rock types within subsurface representations. Subsurface representations with accurate classified rock types may also be used as training data for other machine learning workflows, such as for seismic rock type classification, interpretation, and/or pattern recognition.

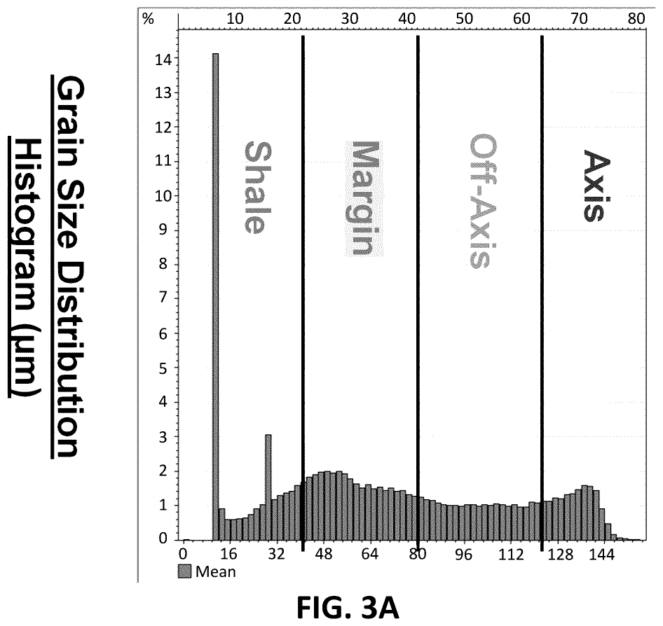

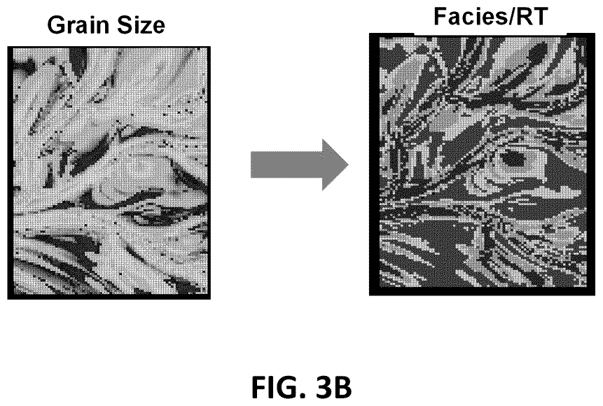

Rock types within subsurface representations may be classified using deterministic thresholding of attributes, such as grain size. FIG. 3A illustrates example grain size distribution histogram for rock types. Rock types may be classified (e.g., as shale, margin, off-axis, axis) based on grain size. FIG. 3B illustrates example classification of rock types. Classification of rock types in FIG. 3B may be performed using deterministic threshold of grain size, such as shown in FIG. 3A. As shown in FIG. 3B, use of deterministic thresholding for rock type classification may produce noisy results due to the prescribed hard cutoff on grain size between facies. For subsurface modeling to be realistic, spatial continuity must exist within rock types. While deep learning approaches for rock type classification have shown promise, they require large amounts of labelled data and are usually performed on a single seismic attribute such as amplitude.

The present disclosure provides a semi-supervised multi-attribute facies classification tool with spatial regularization that can be applied on high resolution physic-based subsurface representations. The rock-type classification tool of the present disclosure may utilize multiple subsurface properties and the spatial distributions or rock types, while having reduced requirements on the number of training labels. The present disclosure may be used to convert subsurface representations with continuous subsurface properties (e.g., continuous property of grain size, flow velocity, sediment concentration, water depth) into discrete rock types. The rock type classification of the present disclosure may smooth out/remove small artifacts in classification. The classified subsurface representations may be used to enhance subsurface modeling and/or characterization capabilities. The classified subsurface representations may be used as training data for subsurface modeling, inversion, and/or other subsurface analysis. For example, the classified subsurface representations may be used as training data in conjunction with seismic data to perform high resolution inversion of rock types from seismic data. Other use of classified subsurface representations are contemplated.

The present disclosure enables use of multiple subsurface properties along with spatial regularization to ensure global consistency in rock type classification. The present disclosure requires a small number of labeled samples to instantiate the classification process. Subsequent labeling process may be bootstrapped as the classification proceeds. For example, a user may be required to provide initial estimate of rock type classification on some portions (e.g., cells, pixels, voxels) of a subsurface representation, with the classification propagating outwards while updating rock type definition.

The present disclosure formulates the classification problem as a global optimization problem with a model fitting that can find globally optimal solutions. The classification problem may be formulated as an energy minimization problem that is solved iteratively. Individual types of rock may be treated as a model and different portions of the subsurface representation may be assigned to a rock type. For example, each cell/voxel in a subsurface representation may be assigned to a rock type. Models for individual rock types may be defined as a multivariate probability density function (PDF) that is fit using a Gaussian Mixture Model (GMM) fit on all subsurface property values for all portions assigned to that rock type. Initial estimates of the PDFs may be determined based on initial rock type classification of some portions of the subsurface representation. At each iteration, all portions of the subsurface representation may be labeled as a particular rock type and PDFs of individual rock types may be re-computed using the updated labeling.

The assignment of different portions of the subsurface representation to different rock types may be governed by an energy function that measures two distinct quantities: (1) difference between current classification of a portion and the most likely classification given the subsurface propert(ies) of the portion, and (2) regularization that enforces spatial continuity of rock type within the subsurface representation. The result is classification of rock types that results in more geologically realistic interpretation of multivariate datasets.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate classifying rock types. The machine-readable instructions 100 may include one or more computer program components. The machine-readable instructions 100 may include a subsurface representation component 102, an initial classification component 104, a probability distribution component 106, a classification component 108, and/or other computer program components.

The subsurface representation component 102 may be configured to obtain subsurface representation information and/or other information. Obtaining subsurface representation information may include one or more of accessing, acquiring, analyzing, creating, determining, examining, generating, identifying, loading, locating, measuring, opening, receiving, retrieving, reviewing, selecting, storing, utilizing, and/or otherwise obtaining the subsurface representation information. The subsurface representation component 102 may obtain subsurface representation information from one or more locations. For example, the subsurface representation component 102 may obtain subsurface representation information from a storage location, such as the electronic storage 13, electronic storage of a device accessible via a network, and/or other locations. The subsurface representation component 102 may obtain subsurface representation information from one or more hardware components (e.g., a computing device, a component of a computing device) and/or one or more software components (e.g., software running on a computing device). Subsurface representation information may be stored within a single file or multiple files.

The subsurface representation information may define a subsurface representation. The subsurface representation information may define a subsurface representation by including information that describes, delineates, identifies, is associated with, quantifies, reflects, sets forth, and/or otherwise defines one or more of content, quality, attribute, feature, and/or other aspects of the subsurface representation. For example, the subsurface representation information may define a subsurface representation by including information that makes up the content of the subsurface representation and/or information that is used to identify/determine the content of the subsurface representation. Other types of subsurface representation information are contemplated.

A subsurface representation may refer to a computer-generated representation of a subsurface region, such as a one-dimensional, two-dimensional, and/or three-dimensional model of a subsurface region. A subsurface representation may be defined by and/or include the subsurface configurations simulated by one or more subsurface models. A subsurface representation may be used as and/or may be referred to as a digital analog. A subsurface representation may include geologically plausible arrangement of rock obtained from a modeling process (e.g., stratigraphic forward modeling process).

A subsurface region may refer to a part of earth located beneath the surface/located underground. A subsurface region may refer to a part of earth that is not exposed at the surface of the ground. A subsurface region may be defined in a single dimension (e.g., a point, a line) or in multiple dimensions (e.g., a surface, a volume).

A subsurface representation may characterize subsurface configuration of a region in the ground (subsurface region). A subsurface representation may characterize subsurface configuration at different locations within a subsurface region. A subsurface representation may characterize (e.g., define, describe, identify, quantify, etc.) subsurface configuration of a subsurface region using values of one or more subsurface properties. The subsurface configuration in different portions of the subsurface representation may be defined by values of subsurface propert(ies) in those portions. For example, the subsurface representation may be made up of cells (e.g., voxels), and the cells may include and/or be associated with particular values of subsurface propert(ies). The cells of the subsurface representation may be used to convey information relating to the subsurface propert(ies) in the corresponding portions of the subsurface representation. For example, the cells of the subsurface representation may include and/or be associated with values of grain size and/or other subsurface properties to represent subsurface configuration in the corresponding portions of the subsurface representation.

Subsurface configuration may refer to attribute, quality, and/or characteristics of a subsurface region. Subsurface configuration may refer to physical arrangement of materials (e.g., subsurface elements) within a subsurface region. Examples of subsurface configuration simulated by a subsurface model may include types of subsurface materials, characteristics of subsurface materials, compositions of subsurface materials, arrangements/configurations of subsurface materials, physics of subsurface materials, and/or other subsurface configuration. For instance, subsurface configuration may include and/or define types, shapes, and/or properties of materials and/or layers that form subsurface (e.g., geological, petrophysical, geophysical, stratigraphic) structures.

A subsurface property may refer to property (e.g., characteristic, trait) of materials in a subsurface region. Examples of subsurface properties include flow velocity, grain size, grain type, grain lithology, porosity, permeability, sediment concentration, water depth, and/or other properties of materials in a subsurface region. Subsurface properties may include one or more geological, petrophysical, geophysical, and/or stratigraphic properties.

A subsurface model may refer to a computer model (e.g., program, tool, script, function, process, algorithm) that generates subsurface representations. A subsurface model may simulate subsurface configuration within a region underneath the surface (subsurface region). A subsurface model may simulate subsurface configurations by generating one or more subsurface representations. An example of a subsurface model is a computational stratigraphy model. A computational stratigraphy model may refer to a computer model that simulates depositional and/or stratigraphic processes on a grain size scale while honoring physics-based flow dynamics. A computational stratigraphy model may simulate rock properties, such as velocity and density, based on rock-physics equations and assumptions. Input to a computational stratigraphy model may include information relating to a subsurface region to be simulated. For example, input to a computational stratigraphy model may include paleo basin floor topography, paleo flow and sediment inputs to the basin, and/or other information relating to the basin. In some implementations, input to a computational stratigraphy model may include one or more paleo geologic controls, such as climate changes, sea level changes, tectonics and other allocyclic controls. Output of a computational stratigraphy model may include one or more subsurface representations. A subsurface representation generated by a computational stratigraphy model may be referred to as a computational stratigraphy model representation.

A computational stratigraphy model may include a forward stratigraphic model. A forward stratigraphic model may be an event-based model, a process mimicking model, a reduced physics based model, and/or a fully physics based model (e.g., fully based on physics of flow and sediment transport). A forward stratigraphic model may simulate one or more sedimentary processes that recreate the way stratigraphic successions develop and/or are preserved. The forward stratigraphic model may be used to numerically reproduce the physical processes that eroded, transported, deposited and/or modified the sediments over variable time periods. In a forward modelling approach, data may not be used as the anchor points for facies interpolation or extrapolation. Rather, data may be used to assess and validate the results of the simulation. Stratigraphic forward modelling may be an iterative approach, where input parameters have to be modified until the results are validated by actual data. Usage of other subsurface models and other subsurface representations are contemplated.

In some implementations, the subsurface representation may characterize subsurface configuration of a real region. For example, the subsurface representation may characterize subsurface configuration of a physical subsurface region, such as a region in the real world (e.g., a real basin, a real reservoir). In some implementations, the subsurface representation may characterize simulated subsurface configuration of a simulated region. For example, the subsurface representation may characterize simulated subsurface configuration of a virtual subsurface region, such as a region in a simulation generating using one or more computer models (e.g., computational stratigraphy models).

In some implementations, a subsurface representation may include a two-dimensional subsurface representation. A two-dimensional subsurface representation may refer to a subsurface representation that exist/extends along two-dimensions. For example, a two-dimensional subsurface representation may represent a slice (e.g., a vertical slice, a horizontal slice, a slanted slice) of a subsurface region. Multiple two-dimensional subsurface representations may be combined to generate a three-dimensional subsurface representation of the subsurface region.

In some implementations, a subsurface representation may include a three-dimensional subsurface representation. A three-dimensional subsurface representation may refer to a subsurface representation that exist/extends along three-dimensions. For example, a three-dimensional subsurface representation may represent a volume (e.g., symmetrical volume, asymmetrical volume) of a subsurface region. A three-dimensional subsurface representation may represent a subsurface region. A three-dimensional subsurface representation may be divided into multiple two-dimensional subsurface representations.

The initial classification component 104 may be configured to obtain initial classification of rock types within portions of the subsurface representation. Obtaining initial classification of rock types may include one or more of accessing, acquiring, analyzing, creating, determining, examining, generating, identifying, loading, locating, measuring, opening, receiving, retrieving, reviewing, selecting, storing, utilizing, and/or otherwise obtaining the initial classification of rock types. Initial classification of rock types may refer to classification of rock types that are to be used as a starting point for rock type classification within the subsurface representation. Initial classification of rock types may refer to initial identification of a particular portion of the subsurface representation as including and/or being of a particular rock type. Initial classification of rock types may refer to initial identification of rock types within portions of the subsurface representation that is used to classify other portions of the subsurface representation. Initial classification of rock types may refer to an initial guess of the rock types within the portions of the subsurface representation. Initial classification of rock types may be used to determine commonalities in subsurface propert(ies) for particular rock types, and these commonalities in subsurface propert(ies) may be used to classify different portions of the subsurface representation. Values of subsurface propert(ies) within the portions of the subsurface representation that are initially classified may be used to build statistics used to classify different portions of the subsurface representation.

Initial classification of rock types may include classification of different portions of the subsurface representation as including and/or being of different rock types. For example, a first portion of a subsurface representation may be initially classified as a first rock type, a second portion of the subsurface representation may be initially classified as a second rock type, and/or other portion(s) of the subsurface representation may be initially classified as other rock type(s). Initial classification of rock types may include classification of any number of rock types.

Initial classification of rock types within portions of the subsurface representation may be obtained from a user, analysis of the subsurface representation and/or other information, and/or other sources. For example, a user may designate certain portions of the subsurface representation as including and/or being of particular rock types. As another example, values of subsurface properties within certain portions of the subsurface representation may be used (e.g., in unsupervised rock classification model) to designate those portions as including and/or being of particular rock types.

One of the benefits of the present disclosure is that the initial classification of rock types need only be obtained for a small portions of the subsurface representation. The initial classification of rock types does not need to be exhaustive to start the rock type classification process. For example, a user does not need to label every cell/voxel of the subsurface representation. Rather, the user only needs to label enough cells/voxels to provide examples of different rock types to be identified within the subsurface representation. Only a few samples of the subsurface representation may need to be initially classified to instantiate the rock type classification process. For example, only a set percentage of the subsurface representation may need to be labeled within the initial classification. Only a set amount of subsurface representation may need to be labeled for individual types of rocks to be identified in the rock type classification. For example, a portion of the subsurface representation that is initially classified as a particular rock type may need to be only large enough to provide enough samples to build a probability distribution for the particular rock type. Additionally, even if the initial classification of rock types includes sparse sampling/labeling of rock types (e.g., few guess of rock types within the subsurface representation), the rock type classification present disclosure may arrive at accurate classification results. Sparse sampling/labeling of rock types in the initial classification may require more iterations of the rock type classification process than more thorough sampling of rock types and may cause delays/require additional computation.

In some implementations, the initial classification of rock types within the portions of the subsurface representation may be obtained from one or more slices of a three-dimensional subsurface representation representing one or more slices of a subsurface region. A slice of a three-dimensional subsurface representation may include a two-dimensional part of the three-dimensional subsurface representation. For example, the there-dimensional subsurface representation may be separated into different slices of same thickness (e.g., vertical slices, horizontal slices, slanted slices), and the initial classification of rock types may be performed within one or more of the slices. The initial classification of rock types of the slice(s) may be used to classify rock types within the slice(s) and/or other slices of the subsurface representation.

In some implementations, the initial classification of rock types within the portions of the subsurface representation may be obtained from one or more three-dimensional parts of the three-dimensional subsurface representation representing one or more three-dimensional parts of the subsurface region: A three-dimensional part of a three-dimensional subsurface representation may include a volume of the three-dimensional subsurface representation. For example, the initial classification of rock types may be performed within one or more paths that moves in three-dimensions within the subsurface representation. The initial classification of rock types of the three-dimensional part(s) may be used to classify rock types within the three-dimensional part(s) and/or other parts of the subsurface representation.

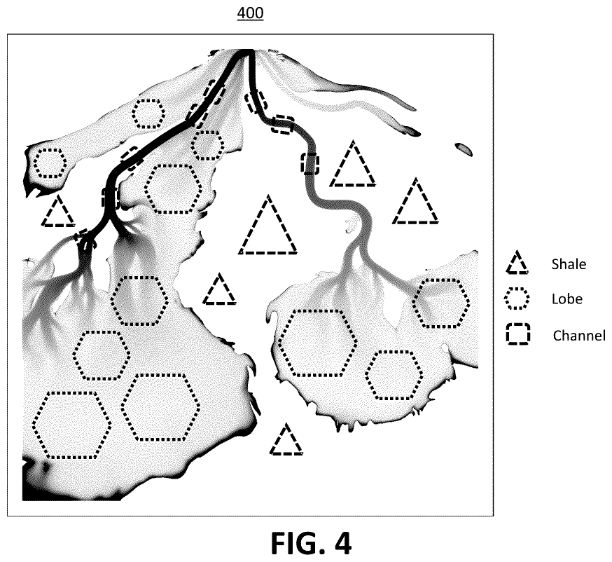

FIG. 4 illustrates an example initial classification of rock types. FIG. 4 shows a slice 400 of a subsurface representation. The initial classification of rock types within the slice 400 may be obtained based on user labeling of different portions of the slice 400 as including and/or being of particular rock types. For example, a user may mark different portions of the slice 400 as being of particular rock types (e.g., shale, lobe, channel). Other initial classification of rock types are contemplated.

The probability distribution component 106 may be configured to determine probability distributions for the rock types. Determining a probability distribution for a rock type may include ascertaining, approximating, calculating, establishing, estimating, finding, identifying, obtaining, quantifying, and/or otherwise determining the probability distribution for the rock type. The probability distributions for the rock types may be determined based on the values of the subsurface propert(ies) within the portions of the subsurface representation and/or other information. A probability distribution for a particular rock type may be determined based on the values of the subsurface propert(ies) with the portion of the subsurface representation that was initially classified as the particular rock type. A probability distribution for a particular rock type may be determined based on the values of the subsurface propert(ies) of the particular rock type from the initial classification of rock types. For example, a first probability distribution for the first rock type may be determined based on the values of the subsurface propert(ies) within the first portion of the subsurface representation initially classified as the first rock type, a second probability distribution for the second rock type may be determined based on the values of the subsurface propert(ies) within the second portion of the subsurface representation initially classified as the second rock type, and other probability distribution(s) for other rock type(s) may be determined based on the values of the subsurface propert(ies) within other portion(s) of the subsurface representation initially classified as the other rock type(s).

A probability distribution may be determined for individual rock types that were included in the initial classification of rock types. A probability distribution may be determined for individual subsurface properties to be used in the classification of rock types. For example, one or more probability distributions for the first rock type may be determined based on the values of the subsurface propert(ies) within the first portion of the subsurface representation initially classified as the first rock type (first facies) and/or other information. One or more probability distributions for the second rock type may be determined based on the values of the subsurface propert(ies) within the second portion of the subsurface representation initially classified as the second rock type (second facies) and/or other information.

A probability distribution may refer to a distribution of values that indicates the probability that a particular part of a subsurface representation is of a particular rock type based on the value of a subsurface property. An individual probability distribution may define likelihood of a given rock type as a function of values of a given subsurface property. In some implementations, a probability distribution may be determined as a probability density function (PDF). A probability density function may include a sum of multiple element probability density functions. For example, a probability distribution for a rock type may be represented as a sum of multiple element probability density functions. For instance, a probability distribution for a rock type may be represented as the superposition of multiple Gaussian kernels using Gaussian mixture modeling (GMM). A single probability distribution may be composed of multiple Gaussian components. Multiple probability distributions corresponding to multiple subsurface properties for a single rock type may provide, be used, and/or be combined as a multi-variate probability distribution for the single rock type. Rather than using deterministic thresholding/clustering of subsurface properties, rock type classification may be performed using the probabilistic representation provided by the probability distributions.

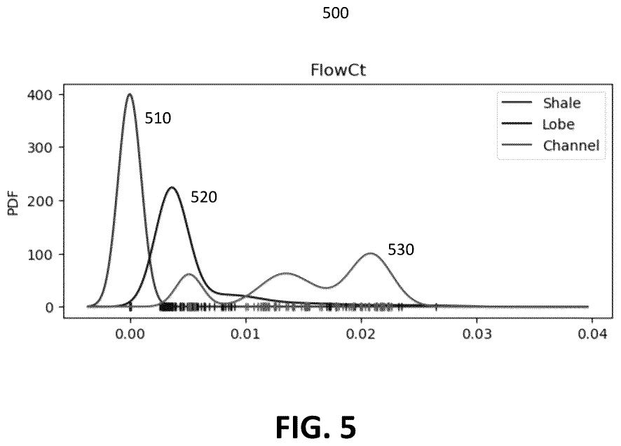

FIG. 5 illustrates example probability distributions 510, 520, 530 for rock types. The probability distributions 510, 520, 530 may define likelihood that a particular portion of the subsurface representation as including and/or being shale, lobe, or channel, respectively, based on values of flow concentration in the particular portion. The probability distributions 510, 520, 530 may be generated based on values of flow concentration in portions of the subsurface representation that were initially classified as being shale, lobe, or channel. In FIG. 5, the probability distribution 510 for shale may overlap with the probability distribution 520 for lobe, and the probability distribution 530 for channel may overlap with the probability distribution 520 for lobe. Overlap in the probability distributions may indicate that deterministic thresholding cannot be used to accurate separate shell from lobe, and lobe from channel in rock type classification. Instead, the probability distributions 510, 520, 530 may be used to perform more accurate rock type classification.

The probabilities of a particular portion of the subsurface representation, which has a particular flow concentration, as including and/or being shale, lobe, or channel may be determined based on ratios of the probability distributions 510, 520, 530 for the particular flow concentration. The probabilities of a particular portion of the subsurface representation as including and/or being a particular rock type may be determined via use of the Bayes rules. The Bayes rules may be used to invert the probability distribution value into a likelihood value for a particular a rock type (e.g., given the probability of flow concentration for shale, determine probability of shale based on a value of flow concentration).

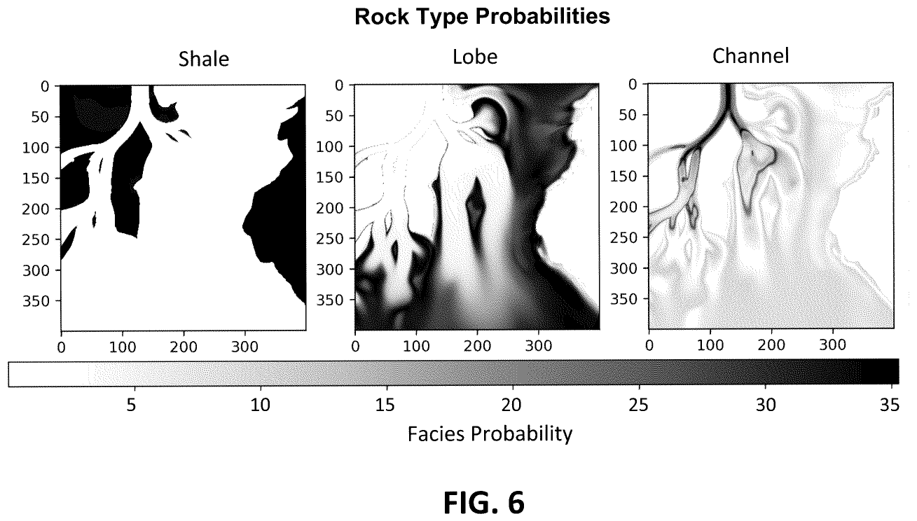

FIG. 6 illustrates example likelihoods for different rock types. The likelihoods of whether a portion of a subsurface representation includes shale, lobe, or channel may be determined based on probabilities distributions of shale, lobe, and channel, and values of one or more subsurface properties (e.g., values of topography, flow velocity, depths, flow concentration). For example, for a particular location within the subsurface representation, the values of topography, flow velocity, depths, flow concentration at the location may be converted into the likelihood that the location includes/is shale, the likelihood that the location includes/is lobe, and the likelihood that the location includes/is channel. Use of other subsurface properties and other rock types are contemplated.

The classification component 108 may be configured to determine classification of rock types within the subsurface representation. Determining classification of rock types within the subsurface representation may include ascertaining, approximating, calculating, establishing, estimating, finding, identifying, obtaining, quantifying, and/or otherwise determining the classification of rock types within the subsurface representation. Determining classification of rock types within the subsurface representation may include identifying the rock types within different portions of the subsurface representation. Determining classification of rock types within the subsurface representation may include determining where the different rock types appear/are located within the subsurface representation. The rock types that are classified within the subsurface representation may include those rock types that were identified in the initial classification of rock types.

The classification of rock types within the subsurface representation may be determined based on the probability distributions for the rock types, a spatial distribution of the classification of rock types within the subsurface representation, and/or other information. Probability distributions for different rock types using a single subsurface property or probability distributions for different rock types using multiple subsurface properties may be used to determine the classification of rock types within the subsurface representation. Spatial distribution of the classification of rock types may refer to show different rock types are spatially distributed throughout the subsurface representation. For example, spatial distribution of the classification of rock types may include whether or not neighboring cells/voxels of the subsurface representation are classified as the same or different rock types. Spatial distribution of the classification of rock types may be used to spatially regularize the classification of rock types within the subsurface representation.

In some implementations, the classification of rock types within the subsurface representation may be determined using an iterative approach in which a global energy function is reduced. A global energy function may refer to a function with value that reflects (1) how well current classification of different portions within the subsurface representation corresponds to rock types indicated by the probability distributions and (2) similarity/dissimilarity between classification of neighboring portions of the subsurface representation. A global energy function may be used to represent the quality of rock type classification as energy values which measures different aspects of what makes a “bad” classification.

The iterative approach may change classification of rock types to until this energy value is minimized. The iterative approach may include updating of the probability distributions for the rock types based on changes in the classification of the rock types. Individual iterations change rock type classification within the subsurface representation, and the probability distribution may be updated to reflect the values of subsurface propert(ies) in the current rock type classification. For example, an initial probability distribution for a rock type may be determined based on the values of a subsurface property within a particular portion of the subsurface representation (e.g., the portion that was initially classified as including/being the rock type). An iteration may change the rock type classification so that two portions of the subsurface representation are now classified as including/being the rock type. The probability distribution for the rock type may be updated to reflect values of the subsurface property within the two portions of the subsurface representation. These changes in probability distributions may in turn change how different portions of the subsurface representation are classified in the next iteration.

In some implementations, the global energy function may include a misfit classification value, a smoothness penalty value, and/or other values. The misfit classification value may refer to a value that reflects how well current classification of different portions within the subsurface representation corresponds to rock types indicated by the probability distributions. The misfit classification value may be determined based on difference between a current classification of a portion (e.g., a given cell) within the subsurface representation and a probabilistic classification of the portion, and/or other information. The probabilistic classification of a particular cell of the subsurface representation may be determined by selecting a particular rock type with the highest likelihood for value(s) of the subsurface propert(ies) associated with the particular portion (e.g., particular cell). For example, if the probability distributions and the subsurface properties of a portion indicates that the portion is more likely to be shale than channel or lobe, then probability classification of the portion may be shale.

The misfit classification value may be the sum of the likelihood of each portion's subsurface properties computed from the probability distributions of the rock types to which they are assigned. The misfit classification value may reflect how well current rock type classification matches the likelihood values from the probability distributions. The misfit classification may ensure that the portions are assigned to their most likely rock type when all subsurface properties are considered.

The smoothness penalty value may refer to a value that reflects similarity/dissimilarity between classification of neighboring portions (e.g., neighboring cells/voxels) of the subsurface representation. The smoothness penalty value may be determined based on difference in classification between neighboring portions (e.g., neighboring cells/voxels) of the subsurface representation, and/or other information. The smoothness penalty value may ensure regularity of rock type assignment for neighboring portions. The smoothness penalty value may apply a regularization on the classification to enforce spatial continuity of the rock types. The labeling/assignment of rock type classification may be considered smooth when neighboring portions of the subsurface representation are classified as being of same rock type. Different classifications of rock types between neighboring portions of the subsurface representation may be penalized as such classification may result in artifacts/noise in the rock type classification.

An example formulation of the global energy function, E(F), for voxels vᵢ∈V and facies fⱼ∈F is provided below. The rock classification process may include labeling/assignment of rock types to different portions of the subsurface representation until the global energy function is minimized. In the below, U_{f}_{ᵥ}(v) (misfit classification value) may be the distance/misfit between voxel v and model fitted to facies fᵥ(PDF), and S(fᵥ, f_{w})w_{pq} (smoothness penalty value) may be the smoothness penalty for neighboring voxels v, w scaled by their distance from each other (closer voxels should be of same label). The w term may control the extent to which the smoothness penalty value is impacted by the distance between different voxels that are compared the rock type similarity (e.g., comparison of a voxel classification with classification of near 20 neighboring voxels, with closer neighboring voxels having greater impact on the smoothness penalty value).

E(F)=Σᵥ^{V}U_{f}_{ᵥ}(v)+λΣ_{(v,w)∈N}^{V}S(fᵥ,f_{w})w_{pq}

The S value in the global energy function may need to be metric (reversible, satisfies triangular inequality etc.). The lambda term may control weighting of the misfit classification value and the smoothness penalty value in the minimization. Other terms may be added to control weighting of the values. The global energy function may provide flexibility in rock type classification. The global energy function provides flexibility in rock type classification. A user may set the parameters of the global energy function (e.g., distance between voxels to be compared, desired spatial smoothness in rock classification) to control how the rock type classification is performed.

In some implementations, weighting may be used to put higher emphasis on subsurface properties that result in better variance of classification. For example, the subsurface representation may characterize the subsurface configuration of a region using values of multiple subsurface properties, and the multiple subsurface properties may be weighted for determination of the misfit classification value. Different subsurface properties may be weighted equally or differently. For example, subsurface properties that are more discriminative of distinct rock types may be weighted more than subsurface properties that are less discriminative. For example, if different values of a subsurface property do not differentiate between different types of rock, then the weight of that subsurface property may be reduced or set to zero.

Minimization of the global energy function may be a combinatorial optimization problem. The global energy function may be translated into a graph, and solved with graph-cut in polynomial time. For example, the global energy function may be re-parameterized as a direct graph and alpha-Expansion algorithm may be applied to come to a solution.

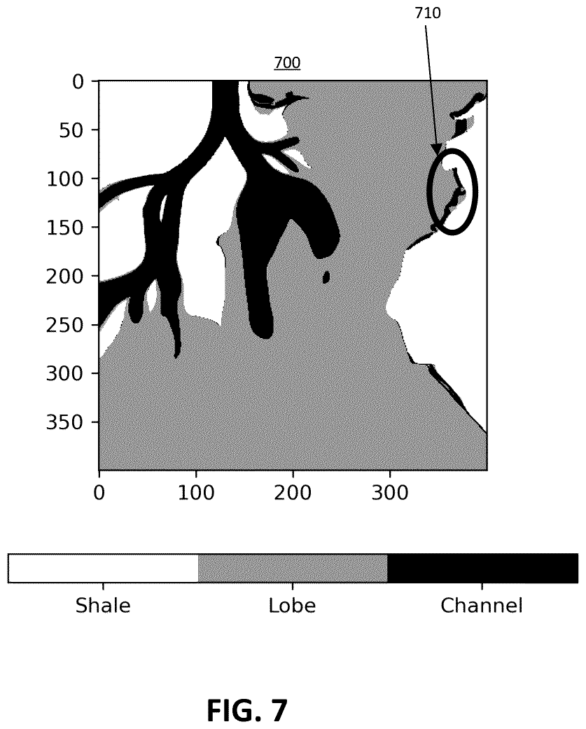

FIG. 7 illustrates an example classification of rock type in a subsurface representation 700 using highest likelihoods for rock types. The rock type classification shown in FIG. 7 may include probabilistic classification of rock types—the rock type classification that would be obtained if the global energy function only included the misfit classification value. In FIG. 7, different portions of the subsurface representation 700 may be classified as rock types with the highest likelihood as determined from the probability distributions of rock types and the values of subsurface properties within the portions. As shown in FIG. 7, even the probabilistic approach for rock type classification may result in artifact/noise. An example artifact/noise is identified at location 710. The artifact/noise may exist in the rock type classification because the spatial regularization (controlled by the smoothness penalty value) has not been applied.

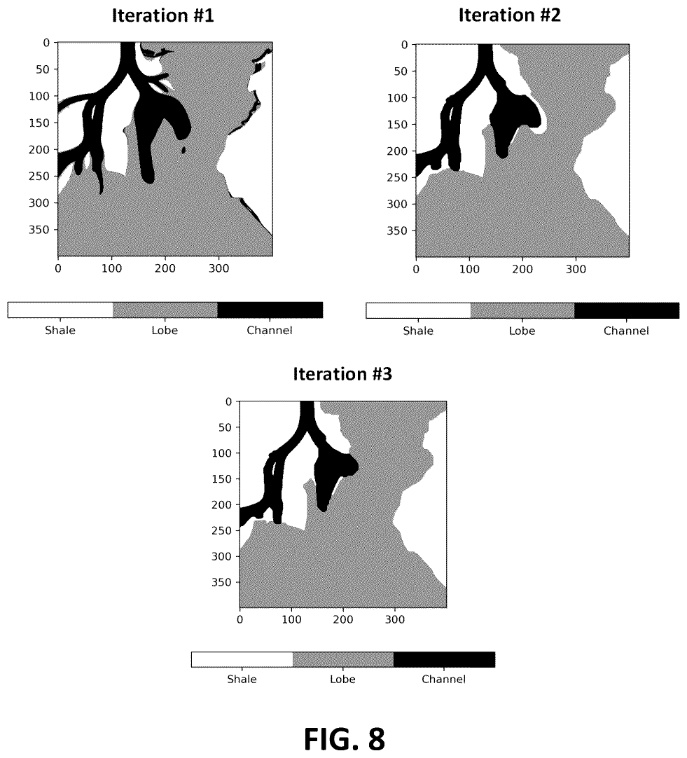

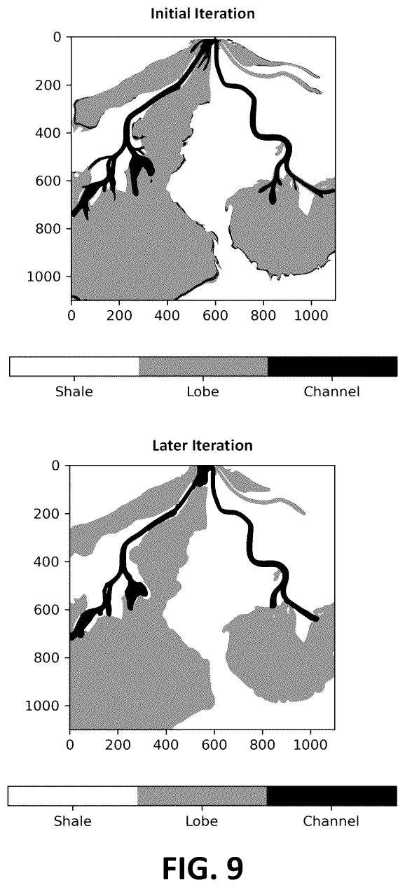

Adding spatial regularization to the global energy function and reiterating on rock classification (changing how different portions of the subsurface representation are classified to reduce the global energy function) may reduce/remove artifacts/noise in the rock type classification. For example, FIG. 8 illustrates example results of iteratively classifying rock types. With each iteration, the amount of artifacts/noise in the rock type classification is reduced. FIG. 9 illustrates another example results of iteratively classifying rock types. FIG. 9 shows the initial result (after one iteration) and a later result (after multiple iterations).

In some implementations, the classification of the rock types within a two-dimensional subsurface representation (representing a slice of a subsurface region) may be used as initial classification of rock types within one or more adjacent two-dimensional subsurface representations. After the rock type classification has been performed (e.g., via the iterative approach) for a slice of a three-dimensional subsurface representation, the results of the rock type classification in the slice may be used as initial classification of rock types in the neighboring slice(s). The results of rock type classification from one slice may be exported to the next slice(s) as the starting point for rock type classification in the next slice(s).

The adjacent two-dimensional subsurface representation(s) may represent one or more adjacent slices of the subsurface region. Multiple two-dimensional subsurface representations, in which the classification of the rock types have been determined, may be combined to generate a three-dimensional subsurface representation for the subsurface region with the classification of the rock types. For example, the three-dimensional subsurface representation for a subsurface region may be divided into slices, and rock type classification may be performed a slice of the three-dimensional subsurface representation. The results of the rock type classification for the slice may be used to perform rock type classification for adjacent slices. Once rock type classification has been performed for all slices, then slices may be combined together. The combination of the classified slices (e.g., labeled slices) may result in a three-dimensional subsurface representation that is already classified (e.g., labeled 3D model).

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

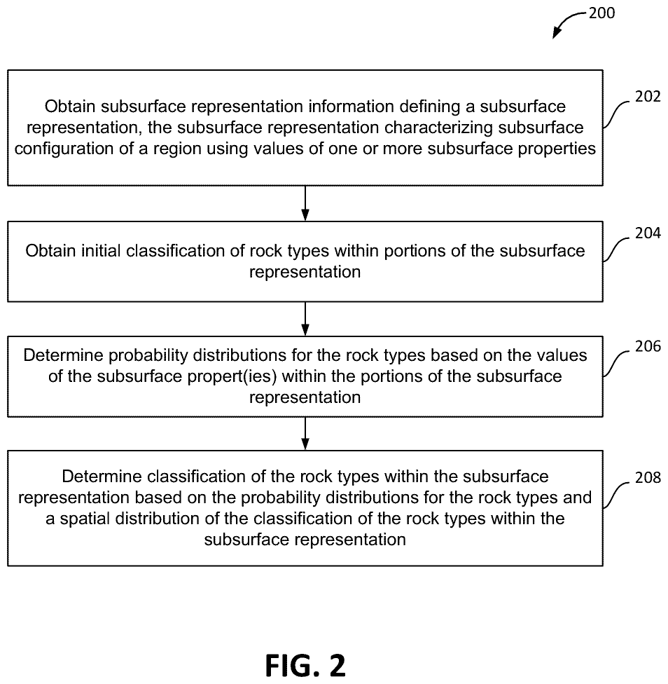

FIG. 2 illustrates method 200 for classifying rock types. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, subsurface representation information and/or other information may be obtained. The subsurface representation information may define a subsurface representation. The subsurface representation may characterize subsurface configuration of a region using values of one or more subsurface properties. In some implementation, operation 202 may be performed by a processor component the same as or similar to the subsurface representation component 102 (Shown in FIG. 1 and described herein).

At operation 204, initial classification of rock types within portions of the subsurface representation may be obtained. A first portion of the subsurface representation may be initially classified as a first rock type, a second portion of the subsurface representation may be initially classified as a second rock type, and/or other portion(s) of the subsurface representation may be initially classified as other rock type(s). In some implementation, operation 204 may be performed by a processor component the same as or similar to the initial classification component 104 (Shown in FIG. 1 and described herein).

At operation 206, probability distributions for the rock types may be determined based on the values of the subsurface propert(ies) within the portions of the subsurface representation and/or other information. One or more probability distributions for the first rock type may be determined based on the values of the subsurface propert(ies) within the first portion of the subsurface representation and/or other information. One or more probability distributions for the second rock type may be determined based on the values of the subsurface propert(ies) within the second portion of the subsurface representation and/or other information. An individual probability distribution may define likelihood of a given rock type as a function of values of a given subsurface property. In some implementation, operation 206 may be performed by a processor component the same as or similar to the probability distribution component 106 (Shown in FIG. 1 and described herein).

At operation 208, classification of the rock types within the subsurface representation may be determined based on the probability distributions for the rock types, a spatial distribution of the classification of the rock types within the subsurface representation, and/or other information. In some implementation, operation 208 may be performed by a processor component the same as or similar to the classification component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for classifying rock types, the system comprising:
one or more physical processors configured by machine-readable instructions to:
obtain subsurface representation information defining a subsurface representation, the subsurface representation characterizing subsurface configuration of a region using values of one or more subsurface properties;
obtain initial classification of rock types within portions of the subsurface representation, wherein a first portion of the subsurface representation is initially classified as a first rock type and a second portion of the subsurface representation is initially classified as a second rock type;
determine probability distributions for the rock types based on the values of the one or more subsurface properties within the portions of the subsurface representation, wherein one or more probability distributions for the first rock type is determined based on the values of the one or more subsurface properties within the first portion of the subsurface representation and one or more probability distributions for the second rock type is determined based on the values of the one or more subsurface properties within the second portion of the subsurface representation, an individual probability distribution defining likelihood of a given rock type as a function of values of a given subsurface property; and
determine classification of the rock types within the subsurface representation based on the probability distributions for the rock types and a spatial distribution of the classification of the rock types within the subsurface representation.

2. The system of claim 1, wherein the classification of the rock types within the subsurface representation is determined using an iterative approach in which a global energy function is reduced.

3. The system of claim 2, wherein the global energy function includes a misfit classification value and a smoothness penalty value, the misfit classification value determined based on difference between a current classification of a given cell within the subsurface representation and a probabilistic classification of the given cell, the smoothness penalty value determined based on difference in classification between neighboring cells of the subsurface representation.

4. The system of claim 3, wherein the probabilistic classification of a particular cell of the subsurface representation is determined by selecting a particular rock type with the highest likelihood for one or more values of the one or more subsurface properties associated with the particular cell.

5. The system of claim 3, wherein the subsurface representation characterizes the subsurface configuration of the region using values of multiple subsurface properties, and the multiple subsurface properties are weighted for determination of the misfit classification value.

6. The system of claim 2, wherein the iterative approach includes updating of the probability distributions for the rock types based on changes in the classification of the rock types.

7. The system of claim 1, wherein:
the subsurface representation includes a two-dimensional subsurface representation, the two-dimensional subsurface representation representing a slice of a subsurface region;
the classification of the rock types within the two-dimensional subsurface representation is used as the initial classification of the rock types within one or more adjacent two-dimensional subsurface representations, the one or more adjacent two-dimensional subsurface representations representing one or more adjacent slices of the subsurface region; and
multiple two-dimensional subsurface representations in which the classification of the rock types have been determined are combined to generate a three-dimensional subsurface representation for the subsurface region with the classification of the rock types.

8. The system of claim 1, wherein:
the subsurface representation includes a three-dimensional subsurface representation, the three-dimensional subsurface representation representing a subsurface region; and
the initial classification of rock types within the portions of the subsurface representation are obtained from one or more slices of the three-dimensional subsurface representation representing one or more slices of the subsurface region.

9. The system of claim 1, wherein:
the subsurface representation includes a three-dimensional subsurface representation, the three-dimensional subsurface representation representing a subsurface region; and
the initial classification of rock types within the portions of the subsurface representation are obtained from one or more three-dimensional parts of the three-dimensional subsurface representation representing one or more three-dimensional parts of the subsurface region.

10. The system of claim 1, wherein the subsurface representation characterizes simulated subsurface configuration of a simulated region.

11. A method for classifying rock types, the method comprising:
obtaining subsurface representation information defining a subsurface representation, the subsurface representation characterizing subsurface configuration of a region using values of one or more subsurface properties;
obtaining initial classification of rock types within portions of the subsurface representation, wherein a first portion of the subsurface representation is initially classified as a first rock type and a second portion of the subsurface representation is initially classified as a second rock type;
determining probability distributions for the rock types based on the values of the one or more subsurface properties within the portions of the subsurface representation, wherein one or more probability distributions for the first rock type is determined based on the values of the one or more subsurface properties within the first portion of the subsurface representation and one or more probability distributions for the second rock type is determined based on the values of the one or more subsurface properties within the second portion of the subsurface representation, an individual probability distribution defining likelihood of a given rock type as a function of values of a given subsurface property; and
determining classification of the rock types within the subsurface representation based on the probability distributions for the rock types and a spatial distribution of the classification of the rock types within the subsurface representation.

12. The method of claim 11, wherein the classification of the rock types within the subsurface representation is determined using an iterative approach in which a global energy function is reduced.

13. The method of claim 12, wherein the global energy function includes a misfit classification value and a smoothness penalty value, the misfit classification value determined based on difference between a current classification of a given cell within the subsurface representation and a probabilistic classification of the given cell, the smoothness penalty value determined based on difference in classification between neighboring cells of the subsurface representation.

14. The method of claim 13, wherein the probabilistic classification of a particular cell of the subsurface representation is determined by selecting a particular rock type with the highest likelihood for one or more values of the one or more subsurface properties associated with the particular cell.

15. The method of claim 13, wherein the subsurface representation characterizes the subsurface configuration of the region using values of multiple subsurface properties, and the multiple subsurface properties are weighted for determination of the misfit classification value.

16. The method of claim 12, wherein the iterative approach includes updating of the probability distributions for the rock types based on changes in the classification of the rock types.

17. The method of claim 11, wherein:
the subsurface representation includes a two-dimensional subsurface representation, the two-dimensional subsurface representation representing a slice of a subsurface region;
the classification of the rock types within the two-dimensional subsurface representation is used as the initial classification of the rock types within one or more adjacent two-dimensional subsurface representations, the one or more adjacent two-dimensional subsurface representations representing one or more adjacent slices of the subsurface region; and
multiple two-dimensional subsurface representations in which the classification of the rock types have been determined are combined to generate a three-dimensional subsurface representation for the subsurface region with the classification of the rock types.

18. The method of claim 11, wherein:
the subsurface representation includes a three-dimensional subsurface representation, the three-dimensional subsurface representation representing a subsurface region; and
the initial classification of rock types within the portions of the subsurface representation are obtained from one or more slices of the three-dimensional subsurface representation representing one or more slices of the subsurface region.

19. The method of claim 11, wherein:
the subsurface representation includes a three-dimensional subsurface representation, the three-dimensional subsurface representation representing a subsurface region; and
the initial classification of rock types within the portions of the subsurface representation are obtained from one or more three-dimensional parts of the three-dimensional subsurface representation representing one or more three-dimensional parts of the subsurface region.

20. The method of claim 11, wherein the subsurface representation characterizes simulated subsurface configuration of a simulated region.
